(19) United States
(12) Patent Application Publication
(10) Pub. No.: US 2019/0319970 A1
(43) Pub. Date: Oct. 17, 2019

(54) NETWORK COMMUNICATIONS PROTOCOL FOR MACHINE-TO-MACHINE SELF ORCHESTRATION

(71) Applicant: Gregory David Pickett, Vincennes, IN (US)

(72) Inventor: Gregory David Pickett, Vincennes, IN (US)

(21) Appl. No.: 16/382,626

(22) Filed: Apr. 12, 2019

Related U.S. Application Data
(60) Provisional application No. 62/656,575, filed on Apr. 12, 2018.

(51) Int. Cl. H04L 29/06; G06F 16/22; G06F 16/23; H04L 12/58

(52) U.S. Cl. CPC H04L 63/1416; H04L 63/1441; H04L 51/04; G06F 16/2379; G06F 16/22

(57) ABSTRACT

A system and method of securing a network including a plurality of computing systems connected via a network. The computing systems each include at least a processor, a memory, a user interface, and a communications interface. The memory includes a computing device-executable instructions (software program) so that, when executed by the processor, the processor: detects an attack event and sends a message comprising the attack event to the other of the plurality of computing systems via the network. Each of the other of the plurality of computing systems receive the message and perform a different response of a plurality of responses to the attack event.

### CROSS-REFERENCE TO RELATED APPLICATION

This application claims the benefit of priority of U.S. provisional application No. 62/656,575, filed Apr. 12, 2019, the contents of which are herein incorporated by reference.

### BACKGROUND OF THE INVENTION

The present invention relates to a network communications protocol for machine-to-machine self-orchestration

Systems that detect, analyze, and respond to events do so in isolation. This isolation requires human intervention. For any enterprise threat, a human must communicate first with the detection system. After communicating with the detection system, a human must transmit events from it to the analysis system. After the analysis system has seen the events, the human must transmit the events to the responding system. Only then can the responding system address the threat. This human intervention results in significant delay. This delay means more damage than there otherwise would have been without this delay. If more events need to be transmitted between systems, then humans are capable of transmitting, threats get missed entirely.

As can be seen, there is a need for a network communications protocol for machine-to-machine self-orchestration.

### SUMMARY OF THE INVENTION

In one aspect of the present invention, a system for securing a network comprises: a computing system of a plurality of computing systems connected via a network, the computing system comprising a processor, a memory, a user interface, and a communications interface, wherein the memory comprises computing device-executable instructions so that, when executed by the processor, the processor: detects an attack event; and sends a message comprising the attack event with the other of the plurality of computing systems via the network, wherein each of the other of the plurality of computing systems receive the message and performs a different response of a plurality of responses to the attack event.

In another aspect of the present invention, a method for securing a network comprises: detecting, via software running on a computing system, an attack event; attaching, via software running on the computing system, the attack event to a message; and sending, via software running on the computing system, the message to a plurality of computing systems connected via a network, wherein each of the other of the plurality of computing systems receive the message and performs a different response of a plurality of responses to the attack event.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a schematic view of an embodiment of the present invention;

FIG. 3 is a schematic view of an embodiment of the present invention;

FIG. 4 is a schematic view of an embodiment of the present invention;

FIG. 5 is a schematic view of an embodiment of the present invention;

and

FIG. 6 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a network communications protocol for machine-to-machine self-orchestration. This network communications protocol allows systems to share events with each other. When one system sees a threat, they all see it and can respond in a coordinated fashion. The network can, quite literally, respond to a threat all on its own and can do so without human interaction. Individual systems are peered with one another. When one system sees an event, it shares the events with all the other systems peered with it. Each individual system sees the event. Each individual system decides when and how to respond to the threat the events represent.

Using the present invention, no human intervention is required. No human must anticipate potential threats and proscribe, or predefine, a response. The systems continue doing what they have been doing. They just now do it together. There is no single point of failure. In the event one system goes down, the others continue to share events and respond to threats without interruption.

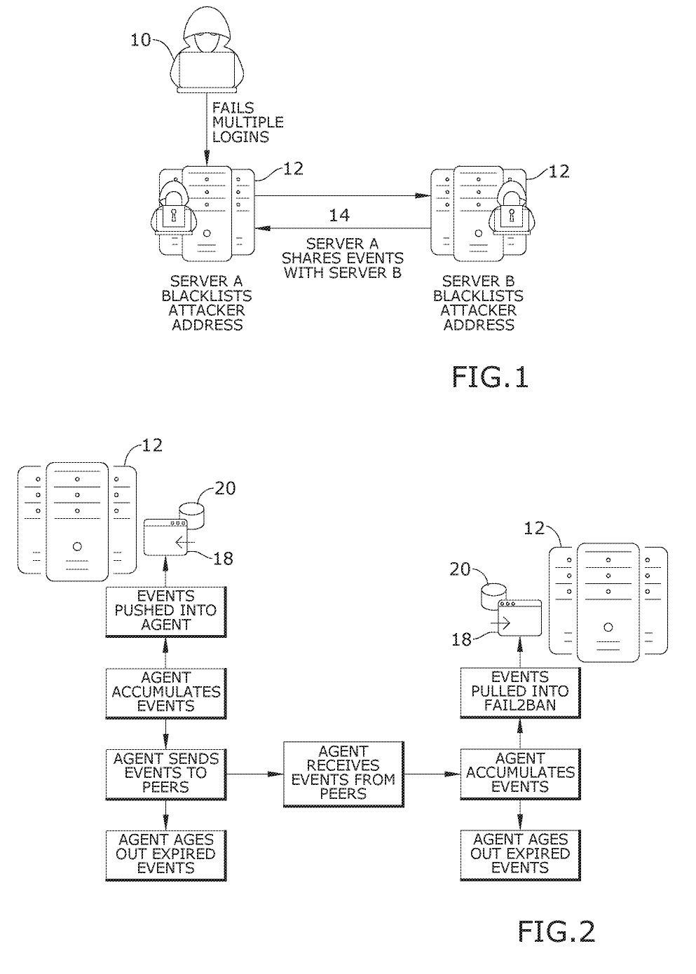

Referring to FIGS. 1 through 6, the present invention includes a system and method of securing a network. The system and method includes a plurality of computing systems 12 connected via a network 14. The computing systems 12 each include at least a processor, a memory, a user interface, and a communications interface. The memory includes a computing device-executable instructions (software program 20) so that, when executed by the processor, the processor: detects an attack event 10 and sends a message comprising the attack event 10 to the other of the plurality of computing systems 12 via the network 14. Each of the other of the plurality of computing systems 12 receive the message and perform a different response of a plurality of responses to the attack event 10. The present invention includes a plurality of computing systems 12 communicating with one another. The computing systems 12 may include, but are not limited to, different types of servers, computers, or combinations thereof. Each of the computing systems 12 include at least the processor and the memory. The computing systems 12 may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing systems 12 include a processor, memory, a user interface, and a communication interface. In particular embodiments, the processor includes hardware for executing instructions, such as those making up the software program 20. The memory includes main memory for storing instructions such as software program(s) 20 for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to the computing systems 12, where appropriate. In particular embodiments, the memory is non-volatile, solid-state memory.

The user interface includes hardware, software, or both providing one or more interfaces for user communication with the computing systems 12. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computing systems 12 on one or more networks 14. As an example, and not by way of limitation, the computing systems 12 may include a communication interface including a network interface card (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems 12 may communicate via an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems 12 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems 12 may include any suitable communication interface for any of these networks, where appropriate.

In certain embodiments, the present invention further includes a database 33 for storing data including a plurality of attack events 10. Each of the plurality of computing systems 12 keeps their own local copy of the database 33 for its' own use. In such embodiments, the computing systems 10 check the database 33 for a match of the attack event 10 and stores the attack event 10 to the database 33 if the match is not found. The computing systems 10 may additionally purge attack events 10 from the database 33 that are stored on the database 33 for a time frame longer than a threshold period of time.

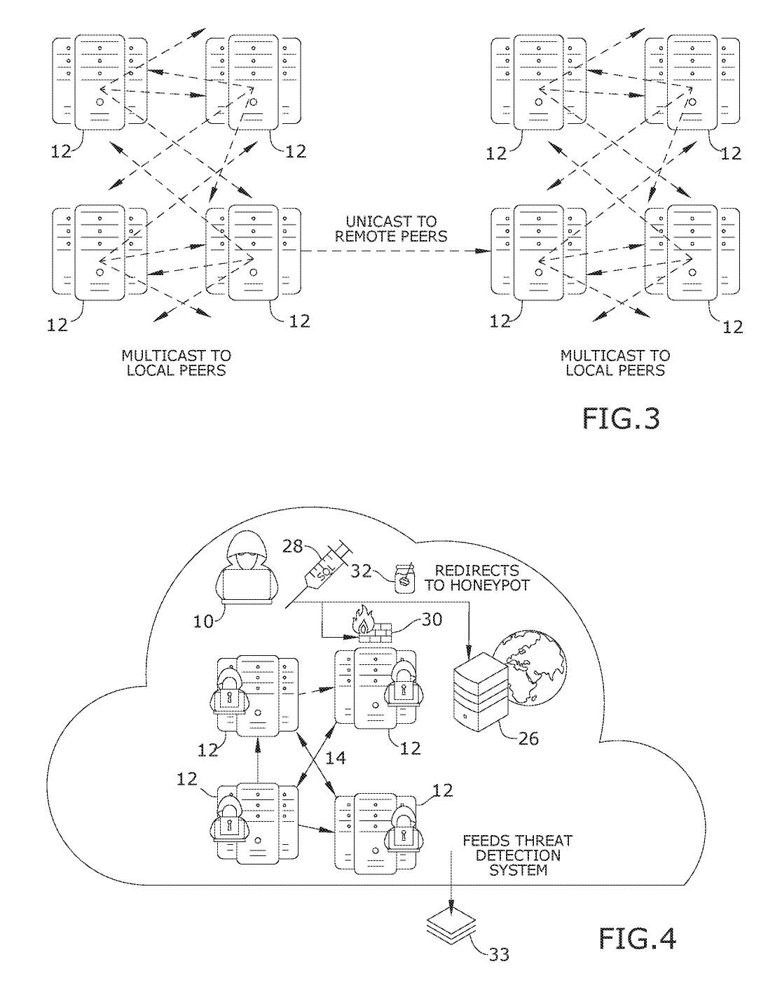

As illustrated in FIG. 3, the present invention may include the network 14 of a plurality of computing systems 12 sharing attack events 10 with a different network 12 of a plurality of computing systems 14. The communication may be a unicast to remote computing systems 14 over the Internet.

In certain embodiments, the message may be signed with a secret key. In such embodiments, the computing system 12 signs the message prior to sharing the message with the other of the plurality of computing systems 12. The computing systems 12 then receive the signed message from one of the other of the plurality of computing systems 12 via the network 14, compares the signature included in the message with its own, and then perform the unique response to the attack event 10. The computing systems 12 may discard the message if the signatures do not match.

The following is a list of method steps that each of the computing systems 12 may take while performing the present invention: listen for messages from local computing systems 12; listen for messages from remote computing systems 12; receive messages from a computing system 12; check messages signature; discard messages with incorrect signature; and extract attack events 10 from messages. The computing device 12 may further retrieve locally occurring attack events 10; check the database if the attack events 10 are already known; if not known, add the attack events 10 to the database 33; make the attack events 10 available for local use; place attack events 10 into messages; sign the message with a secret key; send messages to local computing systems 10; send messages to remote computing systems 10; and remove expired threats from database 33.

Examples of the attack events 10 may include the following: failed logins; injection attempts; exploits detected; malicious files detected; changed files; excessive bandwidth utilized; or any attack that compromise the network 14 and that the system is designed to detect.

Examples of the plurality of functions each computing system 12 performs may include the following: blacklist source of the threat events 10; add source of the threat events to a third party blacklist 10; redirect source of the attack event 10 to a honeypot; redirect source of the attack event 10 to a tarpit; run packet capture on the source of the attack event 10; drop beacon into source of attack event's 10 data stream; change the route for the source of the attack event 10; report the source of the attack event 10 to the abuse address; apply ACL to target of the attack event 10; log the source of the attack event 10; log the target of the attack event 10; start password reset process for the target of the attack event 10; or any function that the computing system 12 is capable of and programmed to perform.

The Figures include examples of how the present invention is used. FIG. 1 illustrates an attacker failing multiple logins, and thereby producing an attack event 10. A first computing system 12 blacklists the attacker address. The first computing system 12 shares the attacker event 10 with a second computing system 12. The second computing system 12 also blacklists the attacker address. Thus, in this situation, the present invention prevents the attacker from logging into either the first computing system 12 or the second computing system.

FIG. 2 illustrates the exchange and accumulation of attack events 10. The software program 20 and user interface 18 are loaded on a first computing system 12 and a second computing system 12. Attack events 10 from the first computing system 12 are sent to the second computing system 12 which accumulates attack events 10. The second computing system 12 further sends attack events 10 to the first computing system 12, which accumulates attack events 10. Both the first computing system 12 and the second computing system 12 age out expired attack events.

FIG. 4 illustrates an attacker launching a SQL injection attack 28 against a website of a computing system 12, such as a webserver 26. The web application firewall 30 on the webserver 26 detects the injection. The attack event 10 is shared with other computing systems 12 within the network 14. The attack event 10 is pulled into the firewall 30 on the webserver 26. The firewall 30 on the webserver 26 redirects the attacker to a computing system 12 that is a honeypot 32. The attack event 10 is directed to other computing systems 12. The other computing systems 12 pull the attack event 10 into their firewalls 30. The firewalls 30 on those computing systems 12 blacklist the attacker. One of the computing systems 12 may also pull that attack event 10 into a separate blacklist, which is shared with remote computing systems 12.

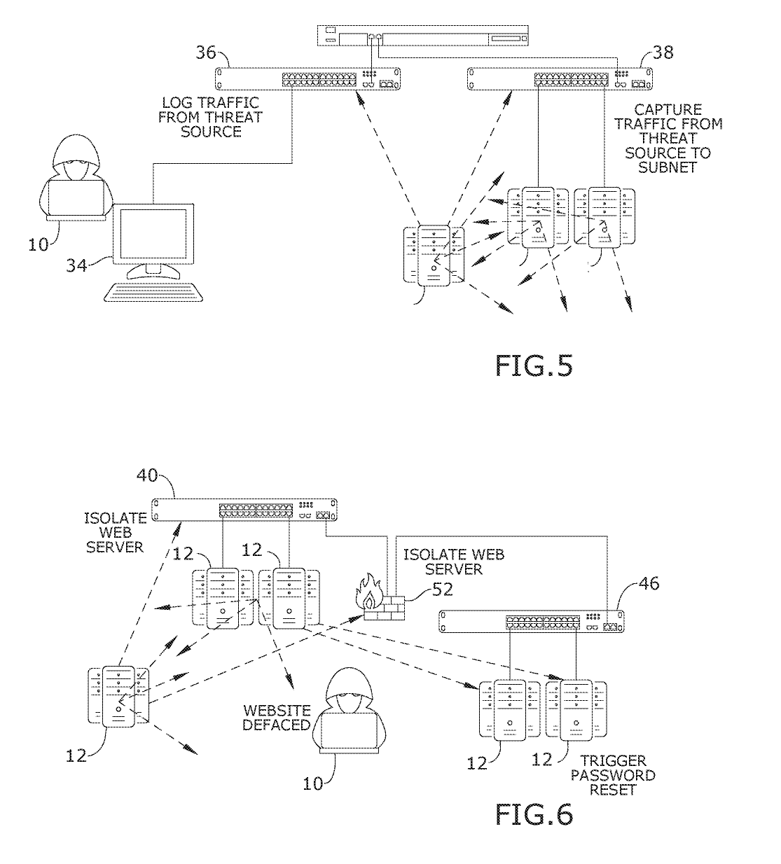

FIG. 5 illustrates an attacker that scans a computing system 12, such as a server in a data center. The endpoint protection 34 on the server in the data center detects the scan. The attack event 10 is pushed to the server and the server in the data center shares that event with other computing systems 12. One of the computing systems 12 (user switch 36) receives the attack event 10 and pulls the attack event 10 into the its' operating system. Its' operating system logs the traffic of the attacker. Another of the computing systems 12 (data center switch 38) also receives the attack event 10. The data center switch 38 pulls the attack event 10 into its operating system. Its operating system captures the packets of the attacker.

FIG. 6 illustrates an attacker defacing a website on a computing system 12 such as a webserver. File integrity monitoring on the webserver detects the defacement. The attack event 10 is pushed by the webserver and the webserver shares that event with other computing systems 12. One of the computing systems 12 (perimeter switch 40) receives the attack event 10. The perimeter switch 40 pulls the attack event 10 into its operating system. Its operating system applies an ACL to isolate the target of the attack event 10 (the web server). Another computing system 12 (perimeter firewall 52) also receives the attack event 10. It pulls the attack event 10 into its operating system. Its operating system applies an ACL to isolate the target of the attack event 10 (the webserver). Another computing system 12 (directory server 46) also receives the event. It pulls the events into a directory. The directory triggers a password reset for the webserver account.

It should be understood, of course, that the foregoing relates to exemplary embodiments of the invention and that modifications may be made without departing from the spirit and scope of the invention as set forth in the following claims.

What is claimed is:

1. A system for securing a network comprising:
a computing system of a plurality of computing systems connected via a network, the computing system comprising a processor, a memory, a user interface, and a communications interface, wherein the memory comprises computing device-executable instructions so that, when executed by the processor, the processor:
detects an attack event; and
sends a message comprising the attack event to the other of the plurality of computing systems via the network, wherein
each of the other of the plurality of computing systems receive the message and performs a different response of a plurality of responses to the attack event.

2. The system of claim 1, further comprising a database storing data comprising a plurality of attack events, wherein the database is accessible by the plurality of computing systems over the network.

3. The system of claim 2, wherein the processor
checks the database for a match of the attack event; and
stores the attack event to the database if the match is not found.

4. The system of claim 1, wherein the processor
signs the message prior to sharing the message with the other of the plurality of computing systems.

5. The system of claim 2, wherein the processor
receives a second message from one of the other of the plurality of computing systems via the network, wherein the second message comprises a second attack event;
signs the message and compares its' signature to the signature included the message;
performs a different response of the plurality of responses to the attack event.

6. The system of claim 1, wherein the message is shared from the plurality of computers with a plurality of remote computers over the Internet.

7. The system of claim 2, wherein the processor
purges attack events from the database that are stored on the database for a time frame longer than a threshold period of time.

8. A method for securing a network comprising:
detecting, via software running on a computing system, an attack event;
attaching, via software running on the computing system, the attack event to a message; and
sending, via software running on the computing system, the message to a plurality of computing systems connected via a network, wherein
each of the other of the plurality of computing systems receive the message and performs a different response of a plurality of responses to the attack event.

9. The method of claim 8, further comprising
accessing, via the software running on the computing system, a database storing data comprising a plurality of attack events.

10. The method of claim 9, further comprising
checking, via the software running on the computing system, the database for a match of the attack event; and
storing, via the software running on the computing system, the attack event to the database if the match is not found.

11. The method of claim 8, further comprising
signing, via the software running on the computing system, the message prior to sharing the message with the other of the plurality of computing systems.

12. The method of claim 11, further comprising
receiving, via the software running on the computing system, a second message from one of the other of the plurality of computing systems via the network, wherein the second message comprises a second attack event;
signing, via the software running on the computing system, the message and comparing a signature to the signature included with the message; and
performing, via the software running on the computing system, a different response of the plurality of responses to the attack event.

13. The method of claim 8, further comprising
sending, via the software running on the computer, the message to a plurality of remote computers over the Internet.

14. The method of claim 9, further comprising
purging, via the software running on the computer, attack events from the database that are stored on the database for a time frame longer than a threshold period of time.
